(19) United States
(12) Patent Application Publication
(10) Pub. No.: US 2026/0348415 A1
(43) Pub. Date: Nov. 5, 2026

(54) METHOD FOR JOINING THREADED RODS

(71) Applicant: Steven Andrew Roth, Alamo, CA (US)

(72) Inventor: Steven Andrew Roth, Alamo, CA (US)

(21) Appl. No.: 19/726,193

(22) Filed: Jun. 30, 2026

Related U.S. Application Data
(63) Continuation-in-part of application No. 19/388,792, filed on Nov. 13, 2025.
(60) Provisional application No. 63/799,898, filed on May 5, 2025.

(51) Int. Cl. F16B 7/18; F16L 3/127

(52) U.S. Cl. CPC F16B 7/18; F16L 3/127

(57) ABSTRACT

A method of joining rods positions a first rod having a first thread parallel to one or more additional rods each having a thread, with the first thread contacting the additional threads along one or more thread contact regions. A compressive force is applied transverse to the rods to at least partially interlock the threads along the contact regions, restricting relative lateral motion of the rods. The joined rods exhibit a greater bending stiffness than any rod alone. The first rod may be supported from an overhead building structure and may support a hanger carrying a conduit, pipe, cable tray, or other building component, and the compressive force may be provided by one or more fasteners, such as a twist tie, clamp, or clip, or by a flexible film.

### CROSS-REFERENCE TO RELATED APPLICATIONS

This application is a continuation-in-part of U.S. Ser. No. 19/388,792, filed Nov. 13, 2025, which claims the benefit of U.S. Provisional Application No. 63/799,898, filed May 5, 2025, the contents of which are hereby incorporated by reference in their entirety.

### BACKGROUND

### Field

This disclosure relates to methods employed in the building construction industry and, more particularly, to a method of stiffening a first rod by joining it to one or more additional rods, the first rod being employed to hold or support pipes, conduits, or other components of a building from building structure.

### Discussion of the Background

In the building construction industry, rods are commonly used to suspend pipes, conduits, cable trays, and other mechanical or electrical components from overhead building structures. To prevent buckling and provide seismic bracing, these threaded rods are often reinforced with stiffener assemblies that couple the rod to an elongated stiffening member running parallel to it.

FIG. 1 is a perspective view of a prior art hanger system 10 supporting a conduit C from the underside of an overhead building structure B. Hanger system 10 includes a rod 13 and a hanger 11. Rod 13 has an upper end 13a that can be attached to or otherwise supported by the underside of an overhead building structure B, and a lower end 13b that passes through hanger 11 that supports conduit C. Rod 13 may, for example and without limitation, be an all-threaded rod having an external thread 15.

Various stiffener arrangements for reinforcing a rod of this type are known in the art. Some employ a clamp disposed inside a channel-shaped stiffener to capture the rod; others use a U-bolt or straight-ended bolt secured to a flat plate by nuts, capturing the rod between the bolt and an adjacent channel. Welding the rod directly to a stiffener is also known. Further known arrangements employ a clamp with an angled cross-segment, or one or more indented plates, to urge the rod toward and hold it in a predetermined lateral position relative to a stiffener member, which may take the form of a channel, square tube, round pipe, or V-shaped section.

These known arrangements suffer from various limitations. U-bolt designs are constrained by the curvature of the bolt and typically cannot accommodate both large-and small-diameter rods with a single assembly. Welded connections are labor-intensive, costly, and permanent, precluding later adjustment or removal. Bolt-and-plate designs are prone to rod slippage under load. The clamp-and-indented-plate assemblies and indented-plate assemblies rely on multiple discrete components that must be aligned and assembled in the field, depend on uniform nut tightening at both ends of the clamp to center the rod, provide only limited points of lateral engagement along the rod, and require complete disassembly of the fastener stack for adjustment or relocation. None of the known arrangements provides a means of indicating proper installation or preload.

Accordingly, a need remains for a method of stiffening a rod that uses a readily available second rod as the stiffening member, accommodates rods of the same or differing diameters and thread pitches, resists relative slippage of the joined rods under load, simplifies field assembly using one or more fasteners, and provides a secure but readily releasable connection between the load bearing rod and the second rod.

### SUMMARY

The problems of the prior art are solved by joining threaded rods arranged in parallel with the threads in contact, and where the rods are held together by a device that provides a compressive force transverse to the rods, resulting in at least partially interlocking the threads of the two rods. The resulting joined rods will have a resistance to bending greater than the rods individually.

Certain aspects provide a method of joining two rods comprising: positioning a first rod having a first thread parallel to a second rod having a second thread, with the first thread contacting the second thread along one or more thread contact regions; and applying a compressive force transverse to the first rod and the second rod to at least partially interlock the first thread and the second thread along the one or more thread contact regions.

Certain other aspects provide a method for joining a first rod supporting a load from an overhead building structure to a second rod, where the method includes positioning the first rod having a first thread parallel to the second rod having a second thread with the first thread contacting the second thread along one or more thread contact regions; and applying a compressive force transverse to the first rod and the second rod sufficient to at least partially interlock the first thread and the second thread along the one or more thread contact regions.

Various other aspects include the joined first rod and second rod having a bending stiffness that is greater than bending stiffness of either of rods, individually.

### BRIEF DESCRIPTION OF THE DRAWINGS

FIG. 1 is a perspective view of a prior art hanger system supporting a conduit from the underside of an overhead building structure;

FIG. 2 is a side view of one stiffening configuration for a rod;

FIGS. 3A and 3B are a front side and end view, respectively, of the fastener of FIG. 2;

FIG. 4 is a side view of a twist tie as a second configuration fastener attaching two rods;

FIG. 5 is a perspective view of a clamp as a third configuration fastener;

FIG. 6 is a side view of the clamp of FIG. 5 attaching two rods;

FIG. 7A is a side view of the clamp of FIG. 5 attaching two rods having the same diameter;

FIG. 7B is a side view of the clamp of FIG. 5 attaching two rods having different diameters; and

FIG. 8 is a is a side view of an alternative clamp attaching three rods.

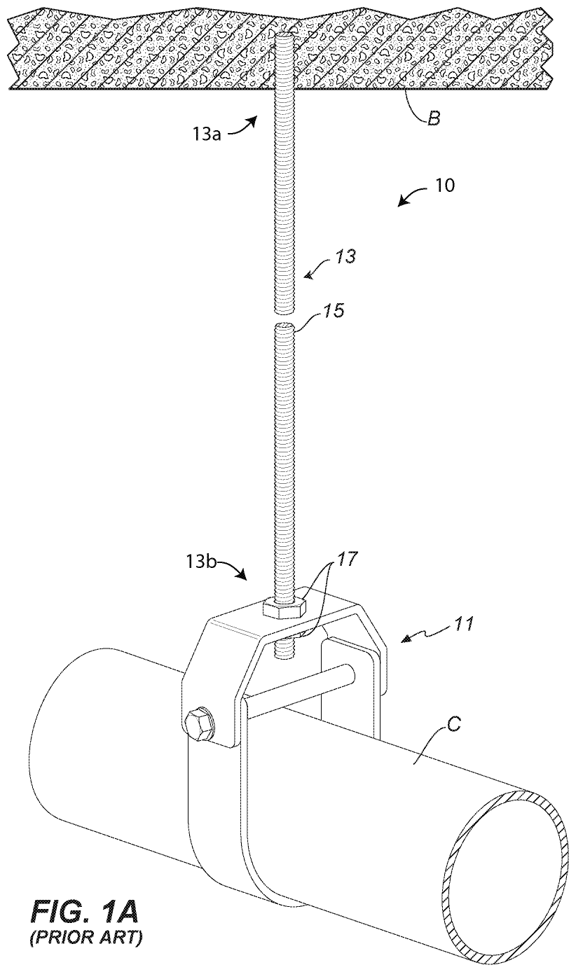

### DETAILED DESCRIPTION

Reference will now be made in detail to the configurations illustrated in the accompanying drawings. Wherever possible, the same reference numerals are used throughout the drawings, and the following description refers to the same or like parts. The drawings are not necessarily to scale, and certain features may be exaggerated or omitted for clarity of illustration. The configurations described below are illustrative of the principles disclosed herein and are not intended to limit the scope of the appended claims. Features described in connection with one configuration may be combined with features described in connection with other configurations except where such combination is explicitly excluded or is apparent from the context to be incompatible.

Certain configurations include a method of joining two or more threaded rods along their lengths by placing the rods parallel to each other with the threads contacting each other and applying a compressive force transverse to the rods sufficient to inhibit or prevent relative longitudinal motion of the rods due to the threads at least partially interlocking with each other. If the thread pitches are the same, the crests and the roots of the adjacent threads will interlock. If the thread pitches differ, then the threads will make contact only at intermittent points along the length where the threads happen to align, and the rods will thus partially interlock. Interlocking the threads in this way restricts or prohibits relative lateral motion of the two rods where the force is applied, resulting in a combination of rods that is stiffer than either rod alone. When the rods are joined in this way, the rods will be stiffer in bending than they are individually.

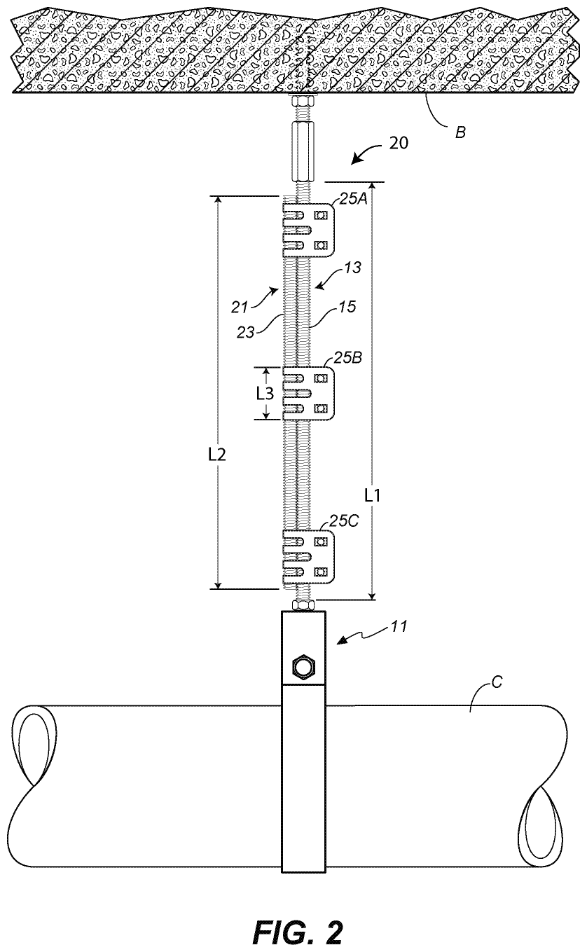

Certain aspects are described with reference to FIG. 2, which is a side view of a pair of joined rods in a configuration 20, where hanger rod 13, also referred to herein as a “first rod,” has a thread 15 and a second rod 21 having thread 23 are joined fasteners 25, illustrated as a first fastener 25A, a second fastener 25B, and a third fastener 25C. First rod 13 may, without limitation, be attached at a first end to an overhead building structure, B, and at a second end attached to a load, illustrated as a conduit C. In various configurations, fasteners 25 are one fastener, two fasteners, three fasteners, or more than three fasteners.

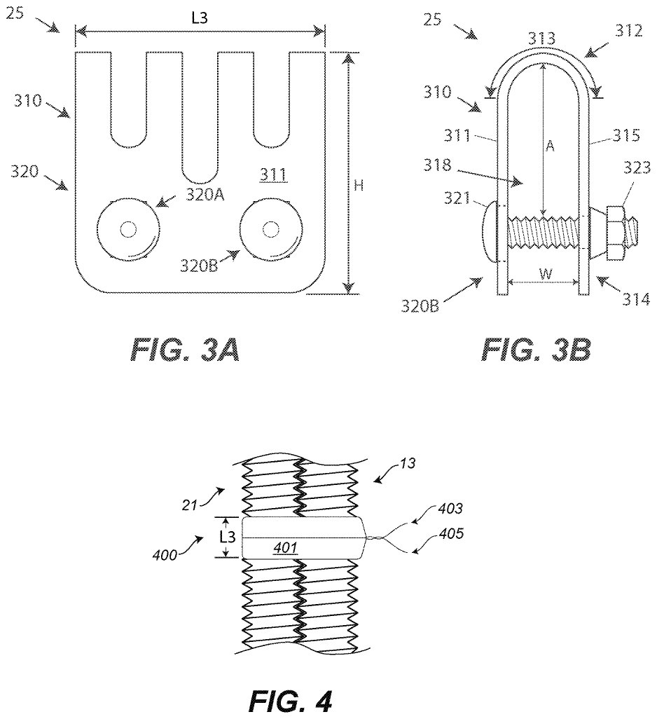

FIGS. 3A and 3B show front and end views of fastener 25, respectively, as described in certain configurations in co-owned U.S. Pat. No. 10,975,900, incorporated herein by reference.

Fastener 25 is a clamp comprising a body 310 having a U shape, a length L3, a width W, and a height H, together with one or more fasteners 320. Body 310 has front and rear portions 311 and 315 joined by a curved portion 313, with the distal end 314 open. Body 310 may be formed from sheet metal and may include optional apertures 316 to reduce stiffness or eliminate non-essential material. Aligned apertures at the distal end receive one or more fasteners 320 (shown as 320A and 320B), each comprising a bolt 321 and nut 323 that, when tightened, draw the front and rear portions together to close the opening. The number of fasteners 320 is selected to provide sufficient clamping force on rods received in enclosed space 318, defined between curved portion 313 and fasteners 320 and having width W and height A.

Two parallel rods placed within the enclosed space are compressed between the curved portion and the tightened fasteners, holding the rods in place and maintaining thread-to-thread contact between them. Thus, fastener 25 can accept length L3 of first rod 13 and second rod 21 within space 318 and the first and second rods are attached by tightening fasteners 320.

While configuration 20 includes three identical fasteners 25, various other configurations may use one fastener, two fasteners, or more than three fasteners, may include a twist tie, a clamp, or a clip, may include a combination of fasteners, or may include one or more elastic elements, such as rubber bands or a flexible film wrapped around the first rod and the second rod and stretched to provide a compressive force transverse to the first rod and the second rod.

In certain configurations, one or both of first rod 13 and second rod 21 are all-threaded rods. In other configurations, first rod 13 and second rod 21 have the same or different diameters and/or have the same or different thread pitches.

FIG. 4 is a side view of a second configuration fastener 400 attaching two rods. Fastener 400 is generally similar to fastener 25 except as explicitly stated.

Fastener 400 is a twist tie having a body 401 of width L3 having a first end 403 and a second end 405. Fastener 400 may be used by wrapping body 401 about first rod 13 and second rod 21 and twisting first end 403 and second end 405, thus attaching the first and second threaded bodies.

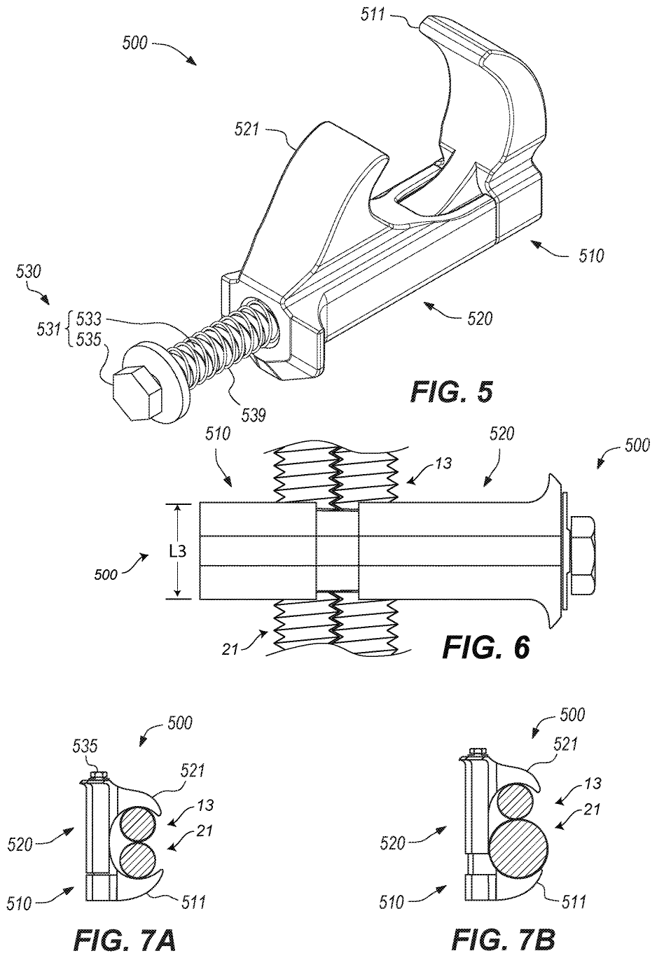

FIG. 5 is a perspective view of a third configuration fastener 500 and FIG. 6 is a side view of fastener 500 attaching first rod 13 and second rod 21 along a length L3. Fastener 500 is generally similar to fastener 400 or 25 except as explicitly stated. In certain configurations, fastener 500 is described in co-owned U.S. patent application Ser. No. 19/388,792, filed Nov. 13, 2025, the contents of which are hereby incorporated by reference.

Fastener 500 includes a distal portion 510, a proximal portion 520, and a tightening mechanism 530. Distal portion 510 has a distal claw 511 and proximal portion 520 has proximal claw 521. Tightening mechanism 530 includes a bolt 531 including thread 533 and a head 535 and a spring 539 positioned about the thread. Distal claw 511 and proximal claw 521 are movable along a length parallel to bolt 531 such that rotation of head 535 moves distal claw 511 and proximal claw 521 towards or away from each other.

Illustrative examples of fastener 500 are shown in FIG. 7A as a side view of the fastener attaching first rod 13 and second rod 21 having the same diameter and in FIG. 7B as a side view of the fastener attaching first rod and second rod having different diameters.

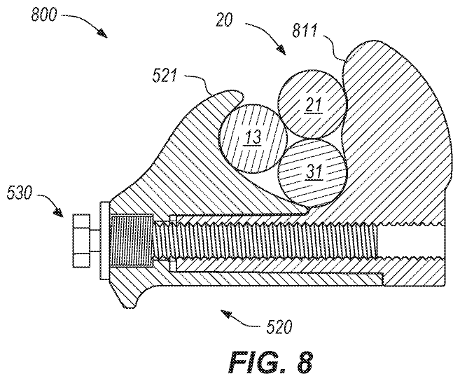

FIG. 8 is a side view of an alternative fastener 800. Fastener 800 is generally similar to fastener 500, except as explicitly noted. Fastener 800 includes a distal claw 811 having detents to accept 2 rods. Thus, for example, fastener 800 can restrain first rod 13, second 21, and a third rod 31, which is a threaded rod and which may be an all-threaded rod. The diameters and thread pitches of first rod 13, second rod 21, and third 31 may be the same, or may include a combination of two or three different diameters and/or two or three different thread pitches. Alternatively, the three rods may be constrained by a twist tie, a clamp, a clip, or elastic elements, as discussed above.

The relative longitudinal motion of rods joined as described herein is inhibited by the interlocking of the threads. In certain configurations, first rod 13, second rod 21, and/or third rod 31 may be each selected, for example and without limitation, from one of a ⅜″-16, a ½″-13, a ⅝″-11, or a ¾″-10 all-threaded rod.

In certain configurations, the joined rods each have the same diameter and thread pitch. In certain other configurations, the diameter and/or thread pitch is not the same for each of the joined rods.

In certain configurations the second rod and/or third rod have same or a larger diameter than the first rod. In certain other configurations the second rod has a smaller diameter than the first rod.

When rods having the same thread pitch and equal or different diameters are joined, the threads nest and overlap, providing a large resistance to any relative longitudinal motion between the rods. The inventor discovered that joining rods with different thread pitches and equal or different diameters also provides resistance to relative longitudinal motion between the rods.

The foregoing description of specific configurations is presented for purposes of illustration and is not intended to be exhaustive or to limit the disclosure to the precise forms disclosed. Although particular fasteners, rod sizes, thread pitches, and stiffener arrangements have been described, these are provided as non-limiting examples, and the principles disclosed herein are not restricted to the specific examples, dimensions, materials, or numerical values set forth.

Where a particular feature, structure, or characteristic is described in connection with one configuration, it is within the knowledge of one skilled in the art to incorporate that feature, structure, or characteristic in connection with other configurations, whether or not explicitly described, except where such combination is expressly excluded or is technically incompatible. The various configurations and features disclosed herein may be used alone or in any combination or subcombination.

The terms “first rod” and “second rod” are used for convenience of reference only and do not denote order, priority, or relative importance, and either rod may serve as the load-bearing first rod or as the stiffening rod. The term “rod” is not limited to all-threaded rod and encompasses any elongated member having a thread along at least a portion of its length, including partially threaded rods, studs, and bolts. The thread contact region or regions may extend continuously or intermittently along any portion of the overlapping lengths of the rods.

The compressive force transverse to the first rod and the second rod may be provided by any means capable of urging the rods together with sufficient force to at least partially interlock the threads, including without limitation one or more clamps, clips, twist ties, bands, straps, collars, crimps, adhesives, heat-shrink or stretch films, or any combination thereof, whether applied at one location or at a plurality of locations along the rods. The number, type, and spacing of such means may be selected as appropriate for a given application.

Recitations of ranges of values herein are intended merely to serve as a shorthand method of referring individually to each separate value falling within the range, and each separate value is incorporated into the specification as if it were individually recited. Terms of approximation, such as “about” or “substantially,” account for ordinary tolerances and variations that do not materially affect the recited function. The use of any and all examples, or exemplary language (“e.g.,” “such as,” “for example,” “without limitation”) is intended merely to better illuminate the disclosure and does not pose a limitation on the scope of the claims.

The methods disclosed herein are not limited to the particular order of steps recited unless a specific order is expressly stated or is necessarily required by the nature of the steps. Steps may be performed sequentially, concurrently, or in a different order, and additional steps may be added or disclosed steps omitted, without departing from the scope of the disclosure.

Accordingly, the scope of protection is not limited by this description but only by the appended claims, and that scope is intended to include all equivalents of the subject matter of the claims. Each claim is hereby incorporated into the detailed description, with each claim standing on its own as a separately claimed configuration.

1. A method of joining rods, the method comprising:
positioning a first rod having a first thread parallel to a second rod having a second thread, with the first thread contacting the second thread along one or more thread contact regions; and
applying a compressive force transverse to the first rod and the second rod to at least partially interlock the first thread and the second thread along the one or more thread contact regions.

2. The method of claim 1, wherein the first rod has a first bending stiffness, and wherein the first rod and the second rod, when joined, have a second bending stiffness that is greater than the first bending stiffness.

3. The method of claim 2, wherein the applying the compressive force comprises applying the compressive force at two or more positions spaced apart along a length of the first rod such that the first rod and the second rod are joined at the two or more positions.

4. The method of claim 1, wherein a length of the second rod is less than a length of the first rod, and wherein the second rod is positioned along a portion of the length of the first rod.

5. The method of claim 1, wherein one or more of the first rod and the second rod is an all-threaded rod.

6. The method of claim 1, wherein the compressive force is provided by one or more fasteners.

7. The method of claim 6, wherein the one or more fasteners are two or more fasteners.

8. The method of claim 6, wherein the one or more fasteners are three or more fasteners.

9. The method of claim 6, wherein the one or more fasteners include a twist tie, a clamp, or a clip.

10. The method of claim 1, wherein the applying the compressive force includes wrapping a flexible film around the first rod and the second rod.

11. The method of claim 1, wherein a thread pitch of the first thread is the same as a pitch of the second thread.

12. The method of claim 11, wherein the first rod and the second rod are both ⅜″-16 rods, both ½″-13 rods, or both ⅝″-11 rods.

13. The method of claim 1, wherein a thread pitch of the first thread is different than a thread pitch of the second thread.

14. The method of claim 13, wherein the first rod is a ⅜″-16 rod and the second rod is either a ½″-13 rod or a ⅝″-11 rod.

15. The method of claim 1, wherein the positioning includes positioning a third rod having a third thread parallel to the first rod and the second rod, with the third thread contacting the first thread along one or more thread contact regions and/or contacting the second thread along one or more thread contact regions; and wherein the applying includes applying a compressive force transverse to the first rod, the second rod, and the third rod to at least partially interlock the third thread with the first thread and/or the second thread along the one or more thread contact regions.

16. The method of claim 1, wherein the first rod is supported from an overhead building structure at an upper end and supports a hanger at a lower end, and wherein the hanger supports a conduit, pipe, cable tray, or another building component.

17. A method for joining a first rod supporting a load from an overhead building structure to one or more second rods, the method comprising:
positioning the first rod having a first thread parallel to one or more second rods each having a second thread, with the first thread contacting the one or more second threads along one or more thread contact regions; and
applying a compressive force transverse to the first rod and the one or more second rods to at least partially interlock the first thread and the one or more second threads along the one or more thread contact regions.

18. The method of claim 17, wherein the first rod has a first bending stiffness, and wherein the joined first rod and the one or more second rods have a second bending stiffness that is greater than the first bending stiffness.

19. The method of claim 17, wherein the one or more second rods have a length less than a length of the first rod, and wherein the one or more second rods are positioned along a portion of the length of the first rod.

20. The method of claim 17, wherein one or more of the first rod and the one or more second rods is an all-threaded rod.

21. The method of claim 17, wherein the compressive force is provided by two or more fasteners.

22. The method of claim 21, wherein the two or more fasteners include a twist tie, a clamp, or a clip.
